(19) United States
(12) Patent Application Publication
(10) Pub. No.: US 2015/0314885 A1
(43) Pub. Date: Nov. 5, 2015

(54) Vision-Based Aircraft Landing Aid

(71) Applicant: ChengDu HaiCun IP Technology LLC, ChengDu (CN)

(72) Inventor: Guobiao ZHANG, Corvallis, OR (US)

(73) Assignee: CHENGDU HAICUN IP TECHNOLOGY LLC, ChengDu (CN)

(21) Appl. No.: 14/637,378

(22) Filed: Mar. 3, 2015

Related U.S. Application Data
(63) Continuation of application No. 13/951,465, filed on Jul. 26, 2013.
(60) Provisional application No. 61/767,792, filed on Feb. 21, 2013.

(51) Int. Cl. B64D 45/08; G06T 7/00; H04N 7/18

(52) U.S. Cl. CPC B64D 45/08; H04N 7/185; G06T 7/004; G06T 2207/10016; G06T 2207/30252

(57) ABSTRACT

The present invention discloses a vision-based aircraft landing aid. During landing, it acquires a sequence of raw runway images. The raw runway image is first corrected for the roll angle (γ). The altitude (A) can be calculated based on the runway width (W) and the properties related to both extended runway edges on the rotated (γ-rotated) runway images. Smart-phone is most suitable for vision-based landing aid.

### CROSS-REFERENCE TO RELATED APPLICATIONS

This is a continuation of an application “Vision-Based Aircraft Landing Aid”, application Ser. No. 13/951,465, filed Jul. 26, 2013, which claims benefits of a provisional application “Vision-Based Aircraft Landing Aid”, Ser. No. 61/767,792, filed Feb. 21, 2013.

### BACKGROUND

1. Technical Field of the Invention

The present invention relates to an aircraft landing aid, more particularly to a landing aid based on computer vision.

2. Prior Arts

Landing is the most challenging part of flying. When an aircraft flies into the ground effect, a pilot initiates a pitch change so that the descent rate of the aircraft can be reduced. This pitch change is referred to as flare, and the time and altitude to initiate flare are referred to as flare time and flare altitude, respectively. For small aircrafts, the flare altitude is typically ˜5 m to ˜10 m above ground level (AGL). Student pilots generally have difficulty judging the flare altitude and need to practice hundreds of landings before getting to know when to flare. Practicing such a large number of landings lengthens the training time, wastes a large amount of fuel and has a negative impact to environment. Although radio altimeter or laser altimeter may be used to help flare, they are expensive. A low-cost landing aid is needed for student pilots to master landing skills quickly and with relative ease.

Computer vision has been used to help landing. U.S. Pat. No. 8,315,748 issued to Lee on Nov. 20, 2012 discloses a vision-based altitude measurement. It uses a circular mark as a landing reference for a vertical take-off and landing aircraft (VTOL). From the acquired image of the circular mark, its horizontal diameter length and the vertical diameter length are measured. The altitude is calculated based on the actual diameter of the circular mark, the distance between the circular mark and the aircraft, and orientation angles (i.e., pitch, roll and yaw angles) of the aircraft. For a fixed-wing aircraft, because the distance between the circular mark and the aircraft's projection on the ground is not a constant, this method cannot be used.

U.S. Pat. No. 5,716,032 issued to McIngvale on Feb. 10, 1998 discloses an automatic landing system using a camera. Two beacons are placed alongside the runway. By processing the image of these two beacons, the automatic landing system calculates the altitude of the aircraft using the distance between two beacons, field of view (FOV) of these beacons, and the pitch angle. However, because McIngvale made a mistake by confusing the pitch angle with the glide path angle, the altitude calculated by McIngvale is incorrect and cannot be used for landing aid.

U.S. Pat. No. 6,57,876 issued to Tarleton Jr. et al. on Dec. 5, 2000 discloses method and apparatus for navigating an aircraft from an image of the runway. After performing the roll-angle correction, Tarleton Jr. uses the center points of both ends of the runway to calculate lateral and vertical deviations of the aircraft with respect to the desired flight path. However, because it did not calculate the absolute altitude of the aircraft, Tarleton Jr. cannot be used for landing aid.

### OBJECTS AND ADVANTAGES

It is a principle object of the present invention to provide a low-cost landing aid.

It is a further object of the present invention to help student pilots to learn landing.

It is a further object of the present invention to provide an automatic landing system.

In accordance with these and other objects of the present invention, a vision-based aircraft landing aid is disclosed.

### SUMMARY OF THE INVENTION

Due to the complexity of the runway image, prior arts could not correctly calculate the altitude of a landing aircraft. The present invention discloses a vision-based aircraft landing aid by correctly calculating the altitude of the landing aircraft from an image of the runway. It comprises a camera and a processor. The camera is mounted in the aircraft forward-facing and acquires a sequence of raw runway images. The processor processes a raw runway image to extract its roll angle γ. After obtaining γ, the raw runway image is corrected by rotating about its principal point by −γ in such a way that the rotated (i.e., γ-corrected) runway image has a horizontal horizon. Further image processing will be carried out on the rotated runway image. Hereinafter, a horizontal line passing the principal point of the rotated runway image is referred to as the principal horizontal line H and a vertical line passing the principal point is referred to as the principal vertical line V. The intersection of the left and right extended runway edges is denoted by P and its coordinate X_{P} (i.e., the distance between the intersection P and the principal horizontal line H) is used to calculate the pitch angle ρ, i.e., ρ=a tan(X_{P}/f), while its coordinate Y_{P} (i.e., the distance between the intersection P and the principal vertical line V) is used to calculate the yaw angle α, i.e., α=a tan[(Y_{P}/f)*cos(ρ)], where f is the focal length of the camera. Finally, the distance Δ between the intersections A, B of both extended runway edges and the principal horizontal line H is used to calculate the altitude of the aircraft A=W*sin(ρ)/cos(α)/(Δ/f), where W is the runway width. Alternatively, the angles θ_{A}, θ_{B} between both extended runway edges and the principal horizontal line H can also be used to calculate the altitude A, i.e., A=W*cos(ρ)/cos(α)/[cot(θ_{A})−cot(θ_{B})].

The landing aid may further comprise a sensor, e.g., an inertia sensor (e.g., a gyroscope) and/or a magnetic sensor (i.e., a magnetometer), which measures the orientation angles (ρ, α, γ). The altitude calculation can be simplified by using these orientation angles measured by the sensor. For example, the measured γ can be directly used to rotate the raw runway image; the measured ρ and α can be directly used to calculate altitude. Using the sensor data reduces the workload of the processor and can expedite image processing.

The vision-based altitude measurement can be implemented as an application software (app) in a smart-phone. A smart-phone has all components needed for vision-based altitude measurement, including camera, sensor and processor. With the ubiquity of the smart-phones, vision-based landing aid can be realized without adding new hardware, but simply by installing a “Landing Aid” app in the smart-phone. This software solution has the lowest cost. The vision-based aircraft landing aid can shorten the pilot training time and therefore, conserve energy resources and enhance the quality of the environment.

### BRIEF DESCRIPTION OF THE DRAWINGS

FIG. 1 illustrates the relative position of an aircraft and a runway;

FIGS. 2A-2C are block diagrams of three preferred vision-based landing aid;

FIG. 3 defines a roll angle (γ);

FIG. 4 is a raw runway image;

FIG. 5 is a rotated (γ-corrected) runway image;

FIG. 6 defines a pitch angle (ρ);

FIG. 7 defines a yaw angle (α);

FIG. 8 discloses the steps of a preferred altitude measurement method;

FIGS. 9A-9B illustrate a preferred gravity-oriented landing aid.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

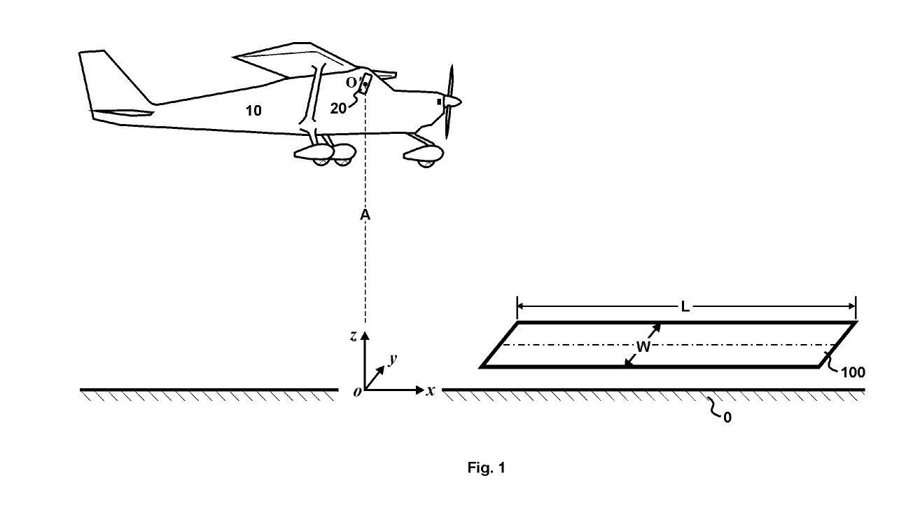

Referring now to FIG. 1, an aircraft 10 with a preferred vision-based landing aid 20 is disclosed. The vision-based landing aid 20 is mounted behind the wind-shield of the aircraft 10 and faces forward. It could be a camera, a computer-like device with camera function, or a cellular phone such as a smart-phone. The principal point of its optics is denoted O′. This landing aid 20 measures its altitude A to the ground 0 using computer vision. A runway 100 is located in the front on the ground 0. Its length is L and width is W. A ground frame is defined as follows: its origin o is the projection of O′ on the ground 0, its x axis is parallel to the longitudinal axis of the runway 100, its y axis is parallel to the lateral axis of the runway 100, and its z axis is perpendicular to its x-y plane. The z axis, uniquely defined by the runway surface, is used as a common reference in many frames (coordinate systems) of the present invention.

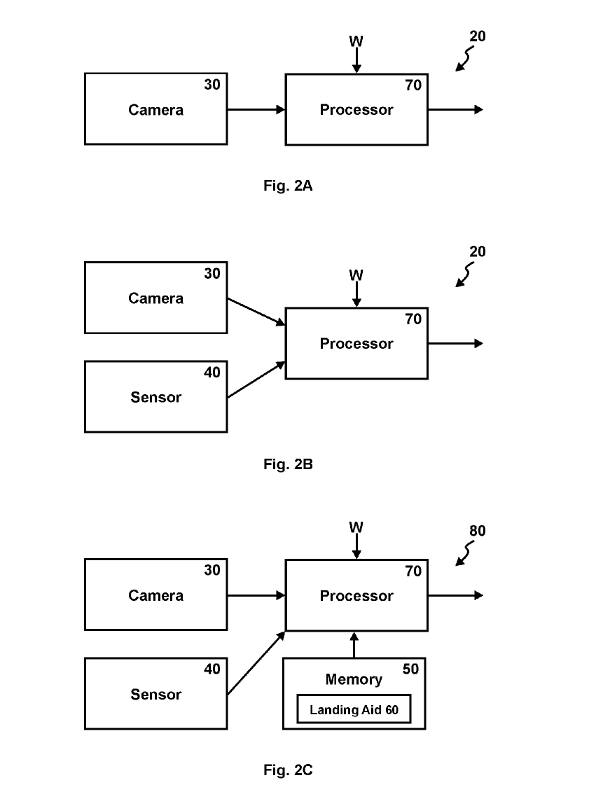

Referring now to FIGS. 2A-2C, three preferred vision-based landing aid 20 are disclosed. The preferred embodiment of FIG. 2A comprises a camera 30 and a processor 70. It calculates altitude A using the runway width W and the image acquired by the camera 30. The runway width W can be manually input with information obtained from the Airport Directory. It may also be retrieved electronically from an airport database. The vision-based landing aid can measure altitude, predict future altitude based on measured data and provide visual/audible instructions to a pilot before decision point. For example, two seconds before a landing maneuver (e.g., flare or a pre-touchdown maneuver), two short beeps and a long beep are generated. The pilot is instructed to ready themselves for the maneuver at the first two short beeps and initiate the maneuver at the last long beep.

Compared with FIG. 2A, the preferred embodiment of FIG. 2B further comprises a sensor 40, e.g., an inertia sensor (e.g., a gyroscope) and/or a magnetic sensor (i.e., a magnetometer), which measures the orientation angles (ρ, α, γ). The altitude calculation is simplified by using these orientation angles. For example, the measured y can be directly used to rotate the raw runway image; the measured ρ and α can be directly used to calculate altitude (referring to FIG. 8). Using the sensor data reduces the workload of the processor and can expedite image processing.

The preferred embodiment of FIG. 2C is a smart-phone 80. It further comprises a memory 50, which stores a landing application software (app) 60. By running the landing app 60, the smart-phone 80 can measure altitude, predict future altitude and provide instructions to a pilot before decision point. With the ubiquity of the smart-phones, vision-based landing aid can be realized without adding new hardware, but simply by installing a “Landing Aid” app in the smart-phone. This software solution has the lowest cost.

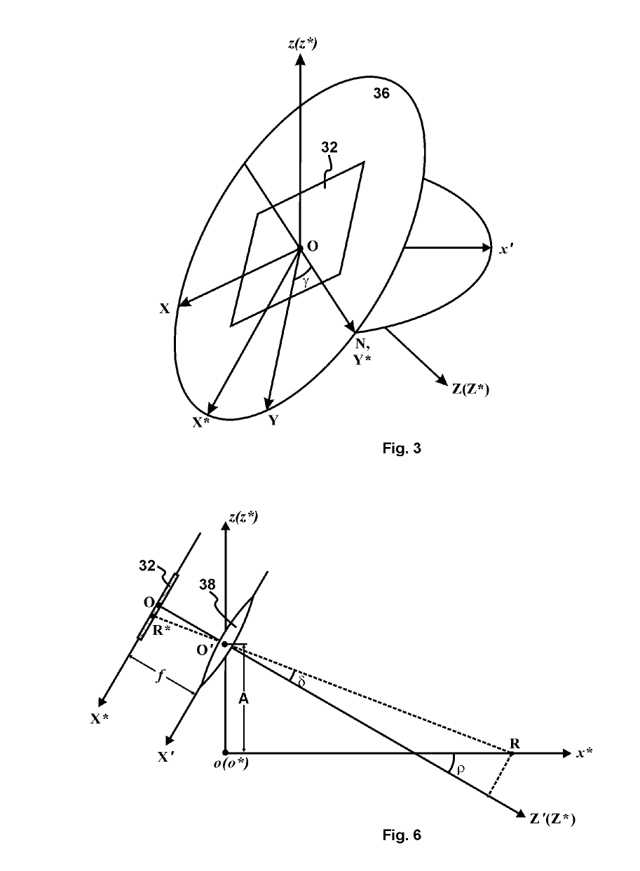

Referring now to FIGS. 3-5, a method to extract the roll angle (γ) on the captured image is described. In FIG. 3, the roll angle (γ) of the camera 30 is defined. Because the image detector 32 (e.g., CCD sensor or CMOS sensor) of the camera 30 is rectangular in an imaging plane 36, a raw image frame can be easily defined: its origin O is the principal point of the detector 32, and its X, Y axis are the center lines of the rectangle with its Z axis perpendicular to the X-Y plane. Here, a line of cord N is defined as the line perpendicular to both z and Z axis and it is always parallel to the runway surface. The roll angle (γ) is defined as the angle between the Y axis and the line N. A rotated (γ-corrected) image frame X*Y*Z* is defined as the image frame XYZ rotated around the Z axis by −γ. Here, the line N is also the Y* axis of the rotated image frame.

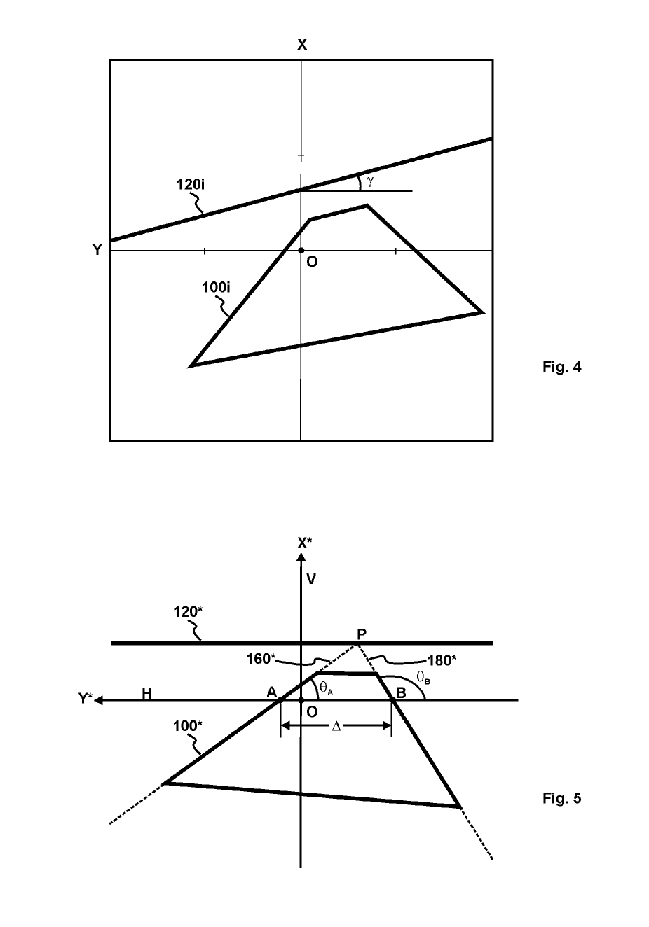

FIG. 4 is a raw runway image 100i acquired by the camera 30. Because the roll angle of the camera 30 is γ, the image 120i of the horizon is tilted. It has an angle γ with the Y axis. The raw runway image 100i is γ-corrected by rotating it around its principal point O by −γ. FIG. 5 is the rotated (γ-corrected) runway image 100*. The image 120* of its horizon is now horizontal, i.e., parallel to the Y* axis. On the rotated runway image, the horizontal line (i.e., Y* axis) passing its principal point O is referred to as the principal horizontal line H and the vertical line (i.e., X* axis) passing its principal point O is referred to as the principal vertical line V. The rotated runway image 100* will be further analyzed in FIGS. 6-8.

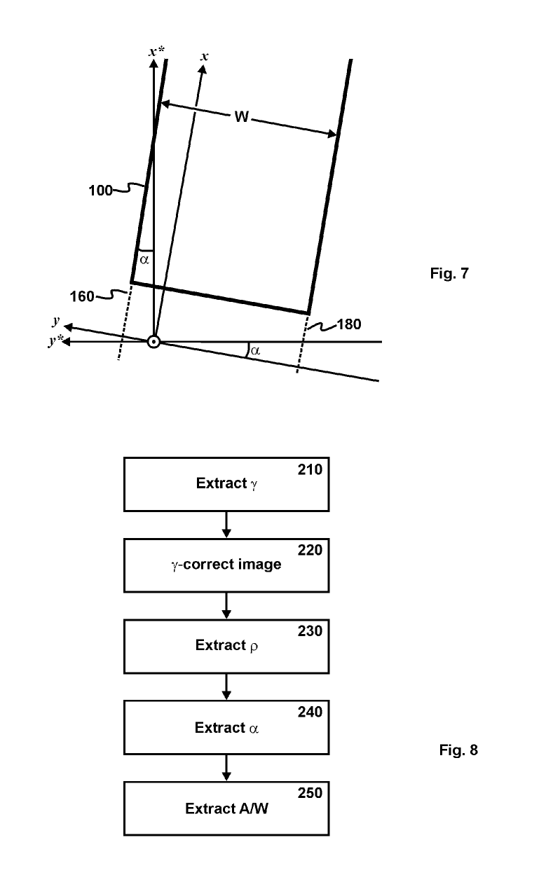

Referring now to FIG. 6, the pitch angle (p) of the camera 30 is defined. An optics frame X′Y′Z′ is defined by translating the rotated image frame X*Y*Z* by a distance of f along the Z* axis. Here, f is the focal distance of the optics 38. Then a rotated (α-corrected, referring to FIG. 7) ground frame x*y*z* is defined. Its origin o* and z* axis is same as the ground frame xyz, while its x* axis is in the same plane as the X′ axis. The distance of the principal point of the optics O′ to the ground (i.e., origin o*) is the altitude A. The pitch angle (ρ) is the angle between the Z′ axis and the x* axis. For a point R on the ground 0 with coordinate (x*, y*, 0) (in the rotated ground frame x*y*z*), the coordinates (X*, Y*, 0) of its image on the image sensor 32 (in the rotated image frame X*Y*Z*) can be expressed as: δ=ρ-a tan(A/x*); X*=−f*tan(δ); Y*=f*y*/sqrt(x*̂2+Â2)/cos(b).

Referring now to FIG. 7, the yaw angle (α) of the camera 30 is defined. This figure shows both the ground frame xyz and the rotated (α-corrected) ground frame x*y*z*. They differ by a rotation of α around the z-axis. Note that α is in reference to the longitudinal axis of the runway 100. Although the x axis is parallel to the longitudinal axis of the runway 100, the rotated ground frame x*y*z* is more computationally efficient and therefore, is used in the present invention to analyze the runway image.

Referring now to FIG. 8, the steps to perform the altitude measurement is disclosed. First of all, the roll angle y is extracted from the horizon 120i of the raw runway image 100i (FIG. 4, step 210). After obtaining γ, the raw runway image 100i is γ-corrected by rotating about its principal point by −γ (FIG. 5, step 220). On the rotated runway image 100*, the intersection of the extended left and right runway edges 160*, 180* is denoted by P. Its coordinates (X_{P}, Y_{P}) (X_{P} is the distance between the intersection P and the principal horizontal line H; Y_{P} is the distance between the intersection P and the principal vertical line V) can be expressed by: X_{P}=f*tan(ρ); Y_{P}=f*tan(α)/cos(ρ). Consequently, the pitch angle ρ can be extracted (FIG. 5, step 230), i.e., ρ=a tan(X_{P}/f); and the yaw angle α can be extracted (FIG. 5, step 240), i.e., α=a tan[(Y_{P}/f)*cos(ρ)].

Finally, the distance Δ between the intersections A, B of both extended runway edges 160*, 180* and the principal horizontal line H is used to extract altitude A (FIG. 5, step 250), i.e., A=W*sin(ρ)/cos(α)/(Δ/f). Alternatively, the angles θ_{A}, θ_{B} between both extended runway edges 160*, 180* and the principal horizontal line H can also be used to extract altitude A, i.e., A=W*cos(ρ)/cos(α)/[cot(θ_{A})−cot(θB)].

It should be apparent to those skilled in the art, the steps in FIG. 8 can change order or be skipped. For example, when the sensor 40 is used to measure orientation angles (ρ, α, γ), the measured γ can be directly used to rotate the raw runway image (skip the step 210); the measured ρ and α can be directly used to calculate altitude (skip the steps 230, 240). Using the sensor data reduces the workload of the processor and can expedite image processing.

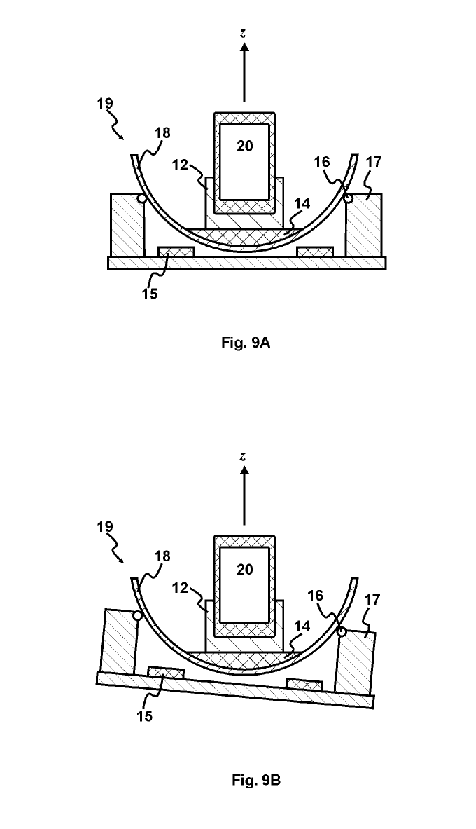

Referring now to FIGS. 9A-9B, a preferred gravity-oriented landing aid 20 is disclosed. It keeps the horizon in the raw runway image horizontal. As a result, the raw runway image does not need to be γ-corrected, which simplifies the altitude calculation. To be more specific, the landing-aid 20 (e.g., a smart-phone) is placed in a gravity-oriented unit 19, which comprises a cradle 18, a weight 14 and a landing-aid holder 12. The cradle 18 is supported by ball bearings 16 on support 17, which is fixed mounted in the aircraft 10. This makes the cradle 18 move freely on the support 17. The weight 14 ensures that the landing aid 20 (e.g., one axis of the image sensor 32) is always oriented along the direction of gravity z, no matter the aircraft 10 is in a horizontal position (FIG. 9A) or has a pitch angle ρ (FIG. 9B). The weight 14 preferably contains metallic materials, and forms a pair of dampers with the magnets 15. These dampers help to stabilize the cradle 18.

While illustrative embodiments have been shown and described, it would be apparent to those skilled in the art that may more modifications than that have been mentioned above are possible without departing from the inventive concepts set forth therein. For example, although the illustrative embodiments are fixed-wing aircrafts, the invention can be easily extended to rotary-wing aircrafts such as helicopters. Besides manned aircrafts, the present invention can be used in unmanned aerial vehicles (UAV). The invention, therefore, is not to be limited except in the spirit of the appended claims.

What is claimed is:

1. A vision-based landing aid apparatus for an aircraft, comprising:
a camera for capturing at least a raw runway image, said raw runway image comprising first and second long edges;
an image processor for calculating an altitude of said aircraft, wherein said image processor is configured to:
rotate said raw runway image to form a rotated runway image having a horizontal horizon and comprising a principal horizontal line and a principal vertical line;
extend said first long edge to intersect said principal horizontal line at a first intersection;
extend said second long edge to intersect said principal horizontal line at a second intersection;
measure a distance (Δ) between said first and second intersections; and
calculate said altitude (A) from A=W*sin(ρ)/cos(α)/(Δ/f), where W is the runway width, f is the focal length, ρ is a pitch angle and a is a yaw angle.

2. The apparatus according to claim 1, wherein said image processor is configured to extend both said first and second long edges to intersect at a third intersection.

3. The apparatus according to claim 2, wherein said image processor is configured to calculate said pitch angle (ρ) from ρ=a tan(Xₚ/f), wherein Xₚ is the distance between said third intersection and said principal horizontal line on said rotated runway image.

4. The apparatus according to claim 2, wherein said image processor is configured to calculate said yaw angle (α) from α=a tan[(Yₚ/f)*cos(ρ)], wherein Yₚ is the distance between said third intersection and said principal vertical line on said rotated runway image.

5. The apparatus according to claim 1, further comprising at least a sensor for sensing at least a roll angle (γ), a pitch angle (ρ), and/or a yaw angle (α) of said camera.

6. The apparatus according to claim 5, wherein said image processor is configured to rotate said runway image based on said roll angle (γ) measured by said sensor.

7. The apparatus according to claim 5, wherein said image processor is configured to calculate said altitude based on said pitch angle (ρ) and said yaw angle (α) measured by said sensor.

8. The apparatus according to claim 1, further comprising an orientation unit for constantly orienting said camera in a fixed direction with respect to said runway.

9. The apparatus according to claim 1, wherein said aircraft is a fixed-wing aircraft, a rotary-wing aircraft, or an unmanned aerial vehicle (UAV).

10. The apparatus according to claim 1, wherein said apparatus is a smart-phone.

11. A vision-based landing aid apparatus for an aircraft, comprising:
a camera for capturing at least a raw runway image, said raw runway image comprising first and second long edges;
an image processor for calculating an altitude of said aircraft, wherein said image processor is configured to:
rotate said raw runway image to form a rotated runway image having a horizontal horizon and comprising a principal horizontal line and a principal vertical line;
measure a first angle (θ_{A}) between said first long edge and said principal horizontal line;
measure a second angle (θ_{B}) between said second long edge and said principal horizontal line; and
calculate said altitude (A) from A=W*cos(ρ)/cos(α)/[cot(θ_{A})−cot(θ_{B})], where W is the runway width, ρ is a pitch angle and α is a yaw angle.

12. The apparatus according to claim 11, wherein said image processor is configured to extend both said first and second long edges to intersect at a third intersection.

13. The apparatus according to claim 12, wherein said image processor is configured to calculate said pitch angle (ρ) from ρ=a tan(Xₚ/f), wherein Xₚ is the distance between said third intersection and said principal horizontal line on said rotated runway image.

14. The apparatus according to claim 12, wherein said image processor is configured to calculate said yaw angle (α) from α=a tan[(γₚ/f)*cos(ρ)], wherein γₚ is the distance between said third intersection and said principal vertical line on said rotated runway image.

15. The apparatus according to claim 11, further comprising at least a sensor for sensing at least a roll angle (γ), a pitch angle (ρ), and/or a yaw angle (α) of said camera.

16. The apparatus according to claim 15, wherein said image processor is configured to rotate said runway image based on said roll angle (γ) measured by said sensor.

17. The apparatus according to claim 15, wherein said image processor is configured to calculate said altitude based on said pitch angle (ρ) and said yaw angle (α) measured by said sensor.

18. The apparatus according to claim 11, further comprising an orientation unit for constantly orienting said camera in a fixed direction with respect to said runway.

19. The apparatus according to claim 1, wherein said aircraft is a fixed-wing aircraft, a rotary-wing aircraft, or an unmanned aerial vehicle (UAV).

20. The apparatus according to claim 11, wherein said apparatus is a smart-phone.
